(19) United States
(12) Patent Application Publication
(10) Pub. No.: US 2026/0166957 A1
(43) Pub. Date: Jun. 18, 2026

(54) AIR CONDITIONER FOR VEHICLE

(71) Applicant: SUBARU CORPORATION, Tokyo (JP)

(72) Inventor: Shuta TAKEDA, Tokyo (JP)

(21) Appl. No.: 19/538,145

(22) Filed: Feb. 12, 2026

Related U.S. Application Data
(63) Continuation of application No. PCT/JP2023/034238, filed on Sep. 21, 2023.

(51) Int. Cl. B60H 1/00; B60H 1/06; B60H 1/22

(52) U.S. Cl. CPC B60H 1/00885; B60H 1/0005; B60H 1/00064; B60H 1/00892; B60H 1/06; B60H 2001/00928; B60H 2001/2253

(57) ABSTRACT

An air conditioner for a vehicle includes a heater core, a water pump, a pump motor, and a control system. The heater core is coupled to an engine cooling pipe. The water pump circulates a coolant inside the cooling pipe. The control system includes a processor and a memory communicably coupled to each other. The control system controls the pump motor in accordance with a heater core temperature. A first threshold and a third threshold lower than the first threshold are set in the control system. The control system operates the pump motor when the heater core temperature decreases to the first threshold after the engine is stopped and starts the engine when, after the temperature of the heater core decreases to the first threshold, the temperature of the heater core becomes equal to or lower than the third threshold while the pump motor is being operated.

### CROSS-REFERENCE TO RELATED APPLICATIONS

This application is continuation of International Application No. PCT/JP2023/034238, filed on Sep. 21, 2023, the entire contents of which are hereby incorporated by reference.

### BACKGROUND

The disclosure relates to an air conditioner for a vehicle.

In a vehicle, a coolant heated by an engine passes through a heater core, causing heat exchange between air in a vehicle compartment and the coolant to thereby warm the air. For example, reference is made to Japanese Unexamined Patent Application Publication Nos. 2021-041807, 2020-196317, 2011-148439, and 2011-116366.

### SUMMARY

An aspect of the disclosure provides an air conditioner for a vehicle. The air conditioner includes a heater core, a water pump, a pump motor, and a control system. The heater core is coupled to a cooling pipe of an engine. The water pump is configured to circulate a coolant inside the cooling pipe. The pump motor is configured to drive the water pump. The control system includes a processor and a memory communicably coupled to each other. The control system is configured to control the pump motor in accordance with a temperature of the heater core. The control system includes a first threshold and a third threshold that are set in the control system. The third threshold is lower than the first threshold. The control system is configured to operate the pump motor when a temperature of the heater core decreases to the first threshold after the engine is stopped and start the engine when, after the temperature of the heater core decreases to the first threshold, the temperature of the heater core becomes equal to or lower than the third threshold while the pump motor is being operated.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating a configuration example of a hybrid electric vehicle including an air conditioning system according to one example embodiment.

FIG. 2 is a diagram illustrating an example of a configuration of the air conditioning system illustrated in FIG. 1.

FIG. 3 is a schematic diagram illustrating a basic configuration of a control unit illustrated in FIG. 2.

FIG. 4 is a timing chart illustrating an example of an operating condition of a water pump illustrated in FIG. 2.

FIG. 5A is a flowchart illustrating an example of a water pump control according to one example embodiment.

FIG. 5B is a flowchart illustrating an example of the water pump control following a process illustrated in FIG. 5A.

FIG. 5C is a flowchart illustrating an example of the water pump control following a process illustrated in FIG. 5A.

FIG. 6 is a diagram illustrating an example of a configuration of an air conditioning system according to one example embodiment.

### DETAILED DESCRIPTION

In a vehicle, a coolant heated by an engine passes through a heater core, causing heat exchange between air in a vehicle compartment and the coolant to thereby warm the air. In an air conditioner for a vehicle (hereinafter simply referred to as a “vehicle air conditioner”), while the coolant heated by the engine is circulated through a water pump, the coolant is passed through the heater core to heat the air. When the engine is stopped in such a vehicle air conditioner, an operation of the pump is also stopped. In this case, the heated coolant is no longer supplied to the heater core, which decreases a temperature of the heater core. To increase the temperature of the heater core, the engine is to be restarted.

However, when the engine is restarted to simply increase the temperature of the heater core, the engine to be stopped is operated unnecessarily. This causes energy used to restart the engine to be wasted. Accordingly, what is desired is to reduce restarting of the engine caused by a decrease in the temperature of the heater core.

It is desirable to provide an air conditioner for a vehicle that makes it possible to reduce restarting of an engine caused by a decrease in a temperature of a heater core.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### First Example Embodiment

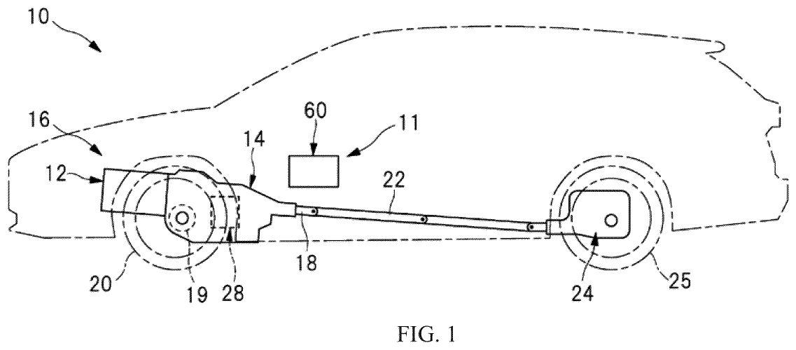

FIG. 1 is a diagram illustrating a configuration example of a hybrid electric vehicle 10 including an air conditioning system 11 according to a first example embodiment. As illustrated in FIG. 1, the hybrid electric vehicle 10 may be an example of a vehicle. The hybrid electric vehicle 10 may be equipped with a powertrain 16 including an engine 12 and a transmission 14. The powertrain 16 may include an output shaft 18. Rear wheels 25 may be coupled to the output shaft 18 via a propeller shaft 22 and a rear differential 24. In addition, a front differential 19 may be incorporated in the transmission 14. Front wheels 20 may be coupled to the front differential 19. In some embodiments, the hybrid electric vehicle 10 may be of a series type, a parallel type, or a series-parallel type.

### <Air Conditioning System>

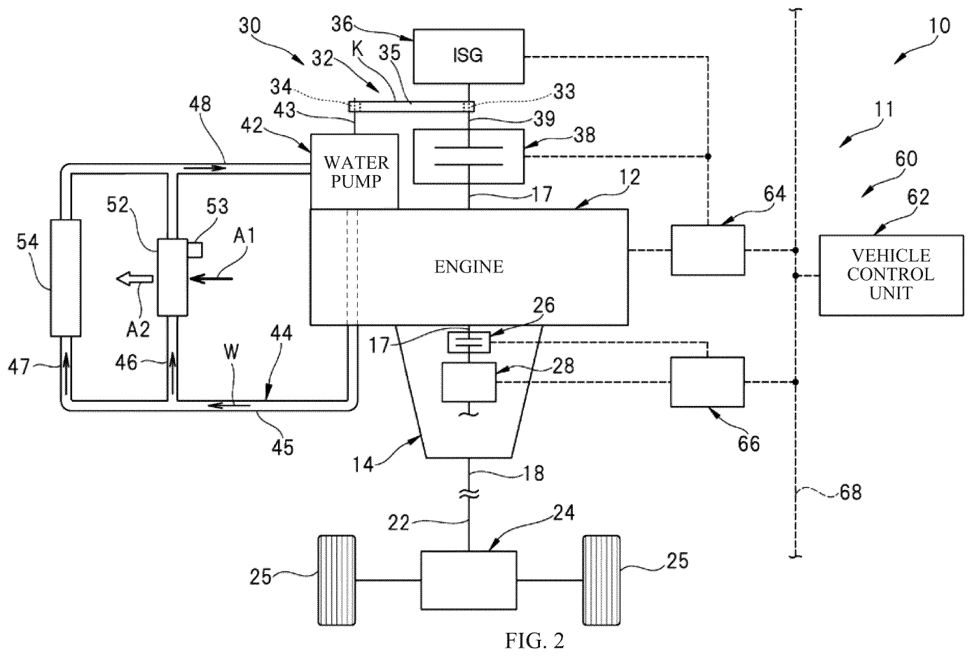

As illustrated in FIG. 2, the air conditioning system 11 may include the engine 12, a heater core 52, a temperature sensor 53, a water pump 42, a drive unit 30, and a control system 60. In one embodiment, the air conditioning system 11 may serve as an “air conditioner for a vehicle”. The hybrid electric vehicle 10 may further be provided with a pipe 44 and a radiator 54.

### <Engine>

The engine 12 may include devices including, without limitation, a crankshaft 17, a throttle valve, an injector, and an ignition device. An engine control unit 64 may be coupled to the devices including, without limitation, the throttle valve, the injector, and the ignition device of the engine 12. The engine control unit 64 may control an operation of the engine 12 by controlling an operation of each of the devices including, without limitation, the throttle valve, the injector, and the ignition device. The engine 12 may output power through the crankshaft 17. The power of the crankshaft 17 may be transmitted to the output shaft 18. Note that the control system 60 may be configured to switch between the engine 12 and a traveling motor 28 to be described later.

The output shaft 18 may extend from the transmission 14 toward a rear of the vehicle. Devices including, without limitation, a switching clutch 26 and the traveling motor 28 may be provided inside the transmission 14. The switching clutch 26 may be, for example, an electromagnetic clutch. The switching clutch 26 may be configured to switch engagement and disengagement between the crankshaft 17 and the output shaft 18. For example, the switching clutch 26 may switch between traveling by the engine 12 and traveling by the traveling motor 28. The traveling motor 28 may be an electric motor. The traveling motor 28 may be configured to perform a power running operation and a regenerative operation. In the regenerative operation, the traveling motor 28 may convert power into electric power and charge a battery via an inverter.

### <Drive Unit>

The drive unit 30 may include a belt mechanism 32, an Integrated Starter Generator (ISG) 36, and a clutch 38. In the drive unit 30, the ISG 36 may drive the water pump 42 via the belt mechanism 32 with the clutch 38 being disengaged.

### <Belt Mechanism>

A path positioned between the ISG 36 and the water pump 42 and through which power is transmitted from the ISG 36 to the water pump 42 may be referred to as a power transmission path K. The belt mechanism 32 may be an example of a transmitter provided in the power transmission path K. For example, the belt mechanism 32 may transmit power from the ISG 36 to the water pump 42. The belt mechanism 32 may include, for example, a pulley 33, a pulley 34, and a belt 35. The pulley 33 may be provided on a coupling shaft 39 of the ISG 36. The pulley 34 may be provided on a rotary shaft 43 of the water pump 42. The belt 35 may be passed over the pulley 33 and the pulley 34. In one embodiment, the belt mechanism 32 may serve as a “transmitter”.

### <ISG>

The ISG 36 may be an example of a pump motor that drives the water pump 42. The ISG 36 may drive the water pump 42 when the engine 12 is stopped. For example, the ISG 36 may include a stator, a rotor, and the coupling shaft 39. A stator coil may be wound around the stator. The rotor may be contained in the stator to be rotatable. The coupling shaft 39 may be secured to the rotor. The ISG 36 may serve as a generator and an electric motor. For example, the ISG 36 may serve not only as the generator that generates electric power based on the power of the engine 12, but also as the electric motor that rotates the crankshaft 17 at the time of starting the engine 12. In one embodiment, the ISG 36 may serve as a “pump motor”.

### <Clutch>

The clutch 38 may be configured to engage and disengage the crankshaft 17 and the coupling shaft 39 with each other or from each other. For example, the clutch 38 may be configured to engage and disengage the engine 12 and the ISG 36 with each other or from each other. As described above, the clutch 38 may be used when switching between transmission of power from the ISG 36 to the engine 12 and interruption of the transmission of power from the ISG 36 to the engine 12. The clutch 38 may be an electromagnetic clutch. The transmission of power and the interruption of the transmission of power at the clutch 38 may be controlled by the control system 60, which will be described later. For example, the clutch 38 may disengage the crankshaft 17 and the coupling shaft 39 from each other when no excitation current flows. The clutch 38 may engage the crankshaft 17 and the coupling shaft 39 with each other when an excitation current flows.

### <Water Pump>

The water pump 42 may include the rotary shaft 43. The rotary shaft 43 may receive a driving force from the coupling shaft 39 via the belt mechanism 32. For example, the water pump 42 may be driven by the engine 12 when the engine 12 is operating regardless of whether the clutch 38 is disengaged or engaged. When the clutch 38 is disengaged, the water pump 42 may be driven by the transmission of power from the ISG 36 via the belt mechanism 32. The water pump 42 may feed a coolant W by pressurizing the coolant W inside the pipe 44. For example, the coolant W may be circulated by receiving a pressurized force of the water pump 42.

### <Pipe>

The pipe 44 may be an example of a cooling pipe through which the coolant W that cools the engine 12 flows. The pipe 44 may include, starting from the water pump 42, an upstream flow path 45, a first flow path 46, a second flow path 47, and a downstream flow path 48. The upstream flow path 45 may extend downstream from the water pump 42 via the engine 12. The coolant W may be heated by receiving heat dissipated from the engine 12 in the upstream flow path 45. In one embodiment, the pipe 44 may serve as a “cooling pipe”.

A downstream end part of the upstream flow path 45 may be branched toward the first flow path 46 and the second flow path 47. A downstream end part of the first flow path 46 and a downstream end part of the second flow path 47 may merge with the downstream flow path 48. A downstream end part of the downstream flow path 48 may be coupled to the water pump 42. This makes it possible for the coolant W to be circulated inside the pipe 44.

### <Heater Core>

The heater core 52 may be coupled to the first flow path 46. The heater core 52 may be in the compartment of the hybrid electric vehicle 10. The heater core 52 may include fins. The fins may transmit the heat of the coolant W in the first flow path 46 to an outside. For example, the heater core 52 may heat air A1 by the heat supplied from the coolant W. The air A1 may be an example of gas.

For example, when the air A1 in the vehicle compartment is sent to the heater core 52 by a device such as a blower fan, the air A1 may remove heat from the coolant W by touching the first flow path 46 and the fins. For example, the air A1 may become heated air A2 and flow into the vehicle compartment. When the heated air A2 flows into the vehicle compartment, the vehicle compartment may be warmed.

### <Temperature Sensor>

The temperature sensor 53 may measure a temperature of the heater core 52. In the present example embodiment, for example, the temperature of the heater core 52 may be directly measured using the temperature sensor 53. In some embodiments, the temperature of the heater core 52 does not have to be directly measured. In some embodiments, when there is a correlation between a temperature of the coolant W that is upstream the heater core 52 in the first flow path 46 and the temperature of the heater core 52, the temperature of the coolant W may be measured by a temperature sensor, and the temperature of the heater core 52 may be obtained based on a correlation coefficient. The temperature sensor 53 may transmit data on the temperature of the heater core 52 to the vehicle control unit 62, which will be described later.

### <Radiator>

The radiator 54 may be provided in the second flow path 47 and positioned outside the vehicle compartment. The radiator 54 may include fins. The fins may transmit the heat of the coolant W in the second flow path 47 to the outside. The radiator 54 may cool the coolant W by removing heat from the coolant W by the air sent to the second flow path 47 and the fins while the hybrid electric vehicle 10 is traveling.

### <Control System>

The control system 60 may include, as a traveling mode of the hybrid electric vehicle 10, an engine mode in which the hybrid electric vehicle 10 is driven by the engine 12, and an electric mode in which the hybrid electric vehicle 10 is driven by the traveling motor 28. The control system 60 may be configured to switch between the engine mode and the electric mode. The control system 60 may engage the clutch 38 when the engine 12 is to be started. The control system 60 may disengage the clutch 38 when the engine 12 is stopped.

The control system 60 may include, for example, multiple electronic control units. Non-limiting examples of the electronic control units may include a vehicle control unit 62, an engine control unit 64, a motor control unit 66, and a battery control unit. The electronic control units including, without limitation, the vehicle control unit 62, the engine control unit 64, the motor control unit 66, and the battery control unit may be communicably coupled to each other via an in-vehicle network 68 such as a Controller Area Network (CAN). The vehicle control unit 62 may output control signals to the electronic control units including, without limitation, the engine control unit 64, the motor control unit 66, and the battery control unit.

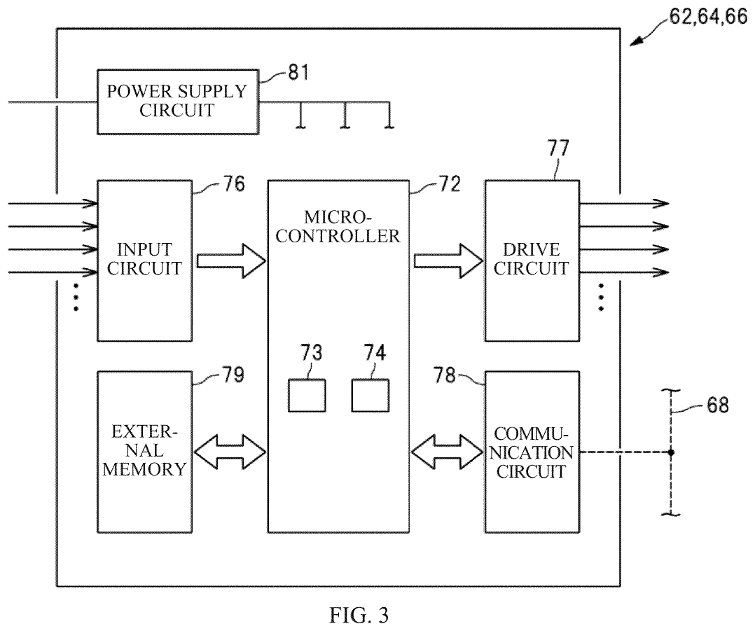

As illustrated in FIG. 3, the vehicle control unit 62, the engine control unit 64, and the motor control unit 66 may each include a microcontroller 72 including, without limitation, a processor 73 and a main memory 74. In one embodiment, the main memory 74 may serve as a “memory”. A predetermined program may be stored in the main memory 74.

The processor 73 and the main memory 74 are communicably coupled to each other. The processor 73 may read the predetermined program from the main memory 74, and expand to execute the program. Accordingly, the program may be executed. In some embodiments, multiple processors 73 may be incorporated in the microcontroller 72. In some embodiments, multiple main memories 74 may be incorporated in the microcontroller 72.

The vehicle control unit 62, the engine control unit 64, and the motor control unit 66 may each include, for example but not limited to, an input circuit 76, a drive circuit 77, a communication circuit 78, an external memory 79, and a power supply circuit 81. The input circuit 76 may convert signals received from various kinds of sensors into signals receivable by the microcontroller 72. The drive circuit 77 may generate drive signals for various kinds of devices including, without limitation, the engine 12, the ISG 36, and the clutch 38, which have been described above, based on signals outputted from the microcontroller 72.

The communication circuit 78 may convert the signals outputted from the microcontroller 72 into communication signals directed to other control units. The communication circuit 78 may also convert communication signals received from the other control units into signals receivable by the microcontroller 72. The power supply circuit 81 may supply a stable power supply voltage to, for example but not limited to, the microcontroller 72, the input circuit 76, the drive circuit 77, the communication circuit 78, and the external memory 79. The external memory 79 may include a memory such as a nonvolatile memory. The external memory 79 may hold programs and various kinds of data, for example.

As illustrated in FIG. 2, the control system 60 may switch the traveling mode of the hybrid electric vehicle 10 from the engine mode to the electric mode, and control the ISG 36 in accordance with the temperature of the heater core 52 after the engine 12 is stopped. For example, when the temperature of the heater core 52 decreases to a threshold after the engine 12 is stopped, the control system 60 may disengage the clutch 38 and drive the water pump 42 by the ISG 36. Note that the threshold will be described later.

### <Description of Threshold>

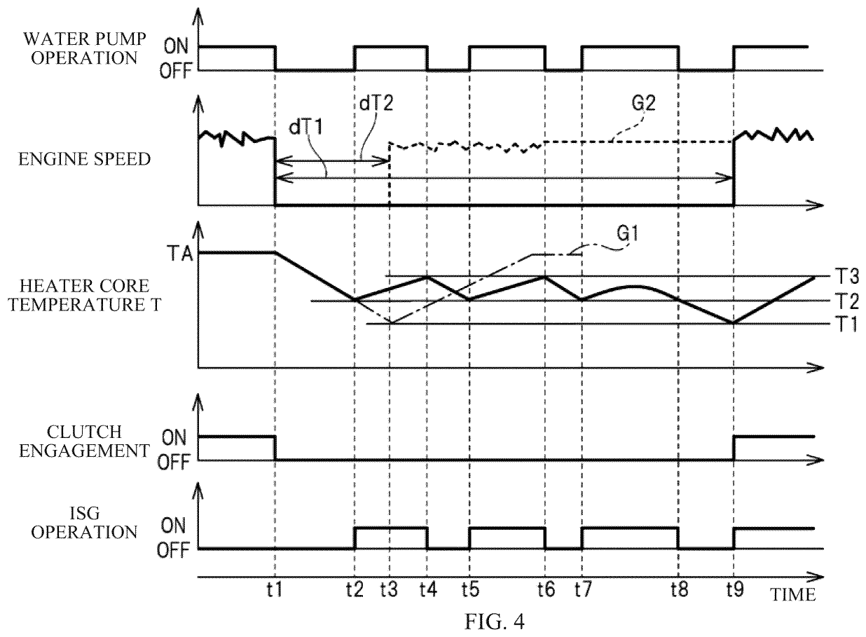

Referring to FIGS. 2 and 4, a first threshold T2, a second threshold T3, and a third threshold T1 that are set in the control system 60 will be described. The temperature of the heater core 52 may be referred to as a heater core temperature T (° C.). The first threshold T2, the second threshold T3, and the third threshold T1 may be set in advance for the heater core temperature T in the control system 60. The first threshold T2, the second threshold T3, and the third threshold T1 may be thresholds used to determine whether various kinds of operations are to be performed in the control system 60.

The first threshold T2 may be an example of a threshold used to determine whether the water pump 42 is to be operated by the ISG 36. When the engine 12 is stopped and the heater core temperature T decreases to the first threshold T2 while the hybrid electric vehicle 10 is traveling, the control system 60 may determine that the water pump 42 is to be operated and cause the ISG 36 to be operated.

The second threshold T3 may be set to a temperature higher than the first threshold T2. The second threshold T3 may be used to determine whether the water pump 42 is to be stopped by the ISG 36. When the heater core temperature T decreases to the first threshold T2 and thereafter becomes higher than the second threshold T3, the control system 60 may determine that the water pump 42 is not to be operated and stop the ISG 36. When the heater core temperature T is higher than the first threshold T2 and lower than the second threshold T3, the control system 60 may continue the operation of the water pump 42.

The third threshold T1 may be set to a temperature lower than the first threshold T2. The third threshold T1 may be used to determine whether the engine 12 is to be operated. In the hybrid electric vehicle 10, there may be a possibility that, after the heater core temperature T decreases to the first threshold T2, the heater core temperature T becomes equal to or lower than the third threshold T1 while the ISG 36 is being operated. For example, when the coolant W is circulated for a long time period in the electric mode, the temperature of the coolant W may decrease with passage of time because the coolant W is unheated. Here, the control system 60 may perform control to engage the clutch 38 and restart the engine 12 when, after the heater core temperature T decreases to the first threshold T2, the heater core temperature T becomes equal to or lower than the third threshold T1 while the ISG 36 is being operated.

### Workings of First Example Embodiment

### <Water Pump Control: Flowchart>

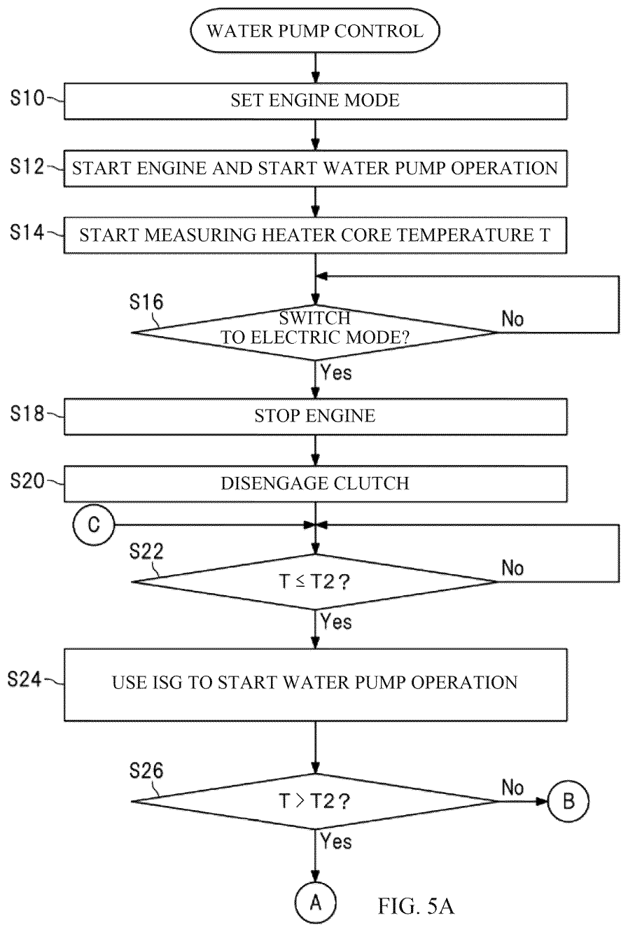

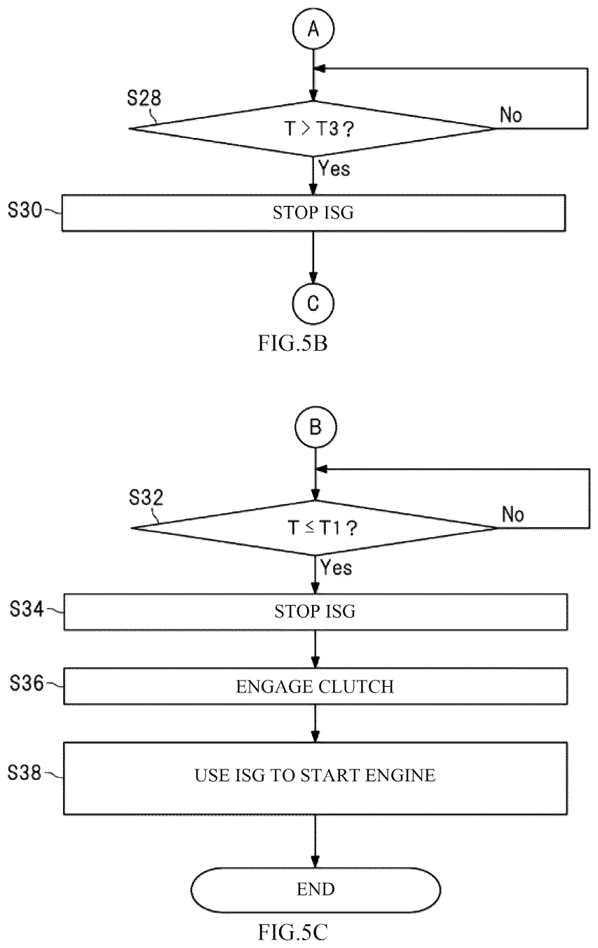

Hereinafter, an execution procedure of a water pump control will be described. FIGS. 5A, 5B, and 5C are flowcharts illustrating an example of the execution procedure of the water pump control. The flowcharts illustrated in FIGS. 5A, 5B, and 5C are coupled to each other by terminals indicated by respective reference characters A, B and C. Further, steps of the water pump control illustrated in FIGS. 5A, 5B, and 5C may be steps to be executed by the processor 73 included in the control system 60. Note that, for components and thresholds of the hybrid electric vehicle 10, FIGS. 1 to 4 will be referenced, and indication of individual figure numbers will be omitted.

As illustrated in FIG. 5A, the control system 60 may cause the process to proceed to step S10 to set the traveling mode of the hybrid electric vehicle 10 to the engine mode. For example, when a remaining battery charge of a battery pack is low, the traveling by the engine 12 may be set. At this time, the clutch 38 may be engaged. Thereafter, the control system 60 may cause the process to shift to step S12.

In step S12, the control system 60 may start the engine 12. For example, the ISG 36 may operate as a starter motor to start the engine 12. When the engine 12 is started, the water pump 42 may start to operate. Thereafter, the control system 60 may cause the process to shift to step S14.

In step S14, the control system 60 may start measuring the heater core temperature T with the temperature sensor 53, and cause the process to shift to step S16. In step S16, the control system 60 may determine whether to switch from the engine mode to the electric mode. For example, when a load at the time of traveling is smaller than a set load, the control system 60 may determine to switch to the electric mode. When switching to the electric mode (S16: Yes), the control system 60 may cause the process to shift to step S18. When not switching to the electric mode (S16: No), the control system 60 may repeat step S16.

In step S18, the control system 60 may stop the engine 12 and cause the process to shift to step S20. In step S20, the control system 60 may disengage the clutch 38 and cause the process to shift to step S22. In step S22, the control system 60 may determine whether the heater core temperature T is equal to or lower than the first threshold T2. When the heater core temperature T is equal to or lower than the first threshold T2 (S22: Yes), the control system 60 may cause the process to shift to step S24. When the heater core temperature T is higher than the first threshold T2 (S22: No), the control system 60 may repeat step S22.

In step S24, the control system 60 may use the ISG 36 to start the operation of the water pump 42. Thereafter, the control system 60 may cause the process to shift to step S26. In step S26, the control system 60 may determine whether the heater core temperature T is higher than the first threshold T2. When the heater core temperature T is higher than the first threshold T2 (S26: Yes), the control system 60 may cause the process to shift to step S28. When the heater core temperature T is equal to or lower than the first threshold T2 (S26: No), the control system 60 may cause the process to shift to step S32.

In step S28, the control system 60 may determine whether the heater core temperature T is higher than the second threshold T3. When the heater core temperature Tis higher than the second threshold T3 (S28: Yes), the control system 60 may cause the process to shift to step S30. When the heater core temperature T is equal to or lower than the second threshold T3 (S28: No), the control system 60 may repeat step S28. In step S30, the control system 60 may stop the operation of the ISG 36 to stop the operation of the water pump 42, and cause the process to shift to step S22.

In step S32, the control system 60 may determine whether the heater core temperature T is equal to or lower than the third threshold T1. When the heater core temperature T is equal to or lower than the third threshold T1 (S32: Yes), the control system 60 may cause the process to shift to step S34. When the heater core temperature T is higher than the third threshold T1 (S32: No), the control system 60 may repeat step S32.

In step S34, the control system 60 may stop the operation of the ISG 36 to stop the operation of the water pump 42, and cause the process to shift to step S36. In step S36, the control system 60 may engage the clutch 38 and cause the process to shift to step S38. In step S38, the control system 60 may use the ISG 36 to start the engine 12. When the engine 12 is started, the water pump 42 may start to operate. Thereafter, the process may be ended.

In some embodiments, the control system 60 may cause the process to shift to step S16 without ending the process in step S38. When a process of shifting the process from step S38 to step S16 is performed, control of the water pump 42 may be to be repeatedly performed. In some embodiments, when the control system 60 acquires a piece of end data of the traveling of the hybrid electric vehicle 10, the program of the water pump control may be ended with the end data serving as a trigger.

### <Water Pump Control: Timing Chart>

The above-described water pump control will be described in accordance with a timing chart. FIG. 4 is the timing chart illustrating an example of control of the water pump 42. For the components of the hybrid electric vehicle 10, FIGS. 1, 2, and 3 will be referenced, and indication of individual figure numbers will be omitted. From time t1 to time t9 illustrated in FIG. 4, time intervals, i.e., lengths of time periods, are exemplary, and control may not be performed in accordance with the illustrated time periods. In practice, a time lag may occur after the control system 60 transmits a control signal to a control target until the control target starts the operation. However, FIG. 4 illustrates the timing chart with the time lag being omitted.

As illustrated in FIG. 4, until before the time t1, the clutch 38 may be engaged. The operation of the ISG 36 may be in a stopped state. The engine 12 may be operating, and the water pump 42 may be operating. The heater core temperature T may be, for example, at a temperature TA. Note that the temperature TA may be, for example, higher than the second threshold T3.

At the time t1, the water pump 42 may be stopped as the engine 12 is stopped. Further, at the time t1, the clutch 38 may be disengaged. During the time period from the time t1 to the time t2, the water pump 42 may be stopped. For example, the coolant W may not be supplied to the heater core 52. Accordingly, the heater core temperature T may decrease from the temperature TA. At the time t2, when the heater core temperature T reaches the first threshold T2, the control system 60 may operate the ISG 36 to start the water pump 42.

When the water pump 42 operates during the time period from the time t2 to the time t4, the coolant W that has passed through the engine 12 may be supplied to the heater core 52. Accordingly, the heater core temperature T becomes higher than the first threshold T2. The operation of the water pump 42 may be continued to maintain the heater core temperature T at a temperature higher than the first threshold T2.

At the time t4, when the heater core temperature T reaches the second threshold T3, the control system 60 may stop the operation of the ISG 36. As a result, the water pump 42 may be stopped. Because the coolant W is no longer circulated, the heater core temperature T may decrease from the second threshold T3. Note that controls performed from the time t5 to the time t6 may be performed in a manner similar to the controls performed from the time t2 to the time t4. The descriptions of the controls performed from the time t5 to the time t6 are therefore omitted.

At the time t7, when the heater core temperature T reaches the first threshold T2, the control system 60 may cause the ISG 36 to operate to start the water pump 42. Thereafter, the water pump 42 may continue to operate during the time period from the time t7 to the time t8. This may cause the coolant W to be supplied to the heater core 52. Accordingly, in some cases, the heater core temperature T may become higher than the first threshold T2.

Here, in a state in which the engine 12 is stopped, there may be no new heating source for the coolant W. The temperature of the coolant W may therefore be lowered by circulation of the coolant W or blowing of the air A1 at the heater core 52. For example, as the time period during which the engine 12 is stopped becomes longer and the time period during which the coolant Wis circulated becomes longer, the temperature of the coolant W may be lowered. Accordingly, even if the operation of the water pump 42 is continued, there may be a possibility that the heater core temperature T becomes lower than the first threshold T2 after a certain point in time. In FIG. 4, the heater core temperature T does not reach the second threshold T3 but decreases to the first threshold T2 during the time period from the time t7 to the time t8.

At the time t8, the control system 60 may determine that it is difficult to increase the heater core temperature T even by circulating the coolant W, and may stop the ISG 36 to stop the water pump 42. The time period from the time t8 to the time t9 may correspond to, for example, a preparation time or a standby time to restart the engine 12.

At the time t9, when the heater core temperature T reaches the third threshold T1, the control system 60 may engage the clutch 38 to operate the ISG 36. As a result, the engine 12 may be restarted and the water pump 42 may also be operated. When the engine 12 is restarted, the engine 12 may heat the coolant W. Thereafter, the coolant W that has been heated may be supplied to the heater core 52 by the water pump 42. As a result, the heater core temperature T may increase from the third threshold T1. In the present example embodiment, the engine 12 may be stopped at the time t1 and restarted at the time t9. A time period from the time t1 to the time t9 may be referred to as a time period dT1. The time period dT1 may be a time period during which the engine 12 is stopped.

### Comparative Example

A dashed-dotted line G1 illustrated in FIG. 4 represents the heater core temperature T in a hybrid electric vehicle according to a comparative example of the present example embodiment. A dotted line G2 illustrated in FIG. 4 represents the engine speed of the hybrid electric vehicle of the comparative example. In the hybrid electric vehicle of the comparative example, the water pump may remain stopped after the engine is stopped. Accordingly, when the heater core temperature T decreases to the third threshold T1 at the time t3, the engine is to be restarted to operate the water pump. For example, in the hybrid electric vehicle of the comparative example, a time period dT2 from the time t1 to the time t3 may be a time period during which the engine is stopped. The time period dT2 may be shorter than the time period dT1.

### Summary of First Example Embodiment

As described above, in the air conditioning system 11, when the temperature of the heater core 52 decreases to the first threshold T2 after the engine 12 is stopped, the control system 60 operates the ISG 36 to drive the water pump 42. As a result, the coolant W heated by receiving the heat dissipated from the engine 12 may be supplied to the heater core 52, causing the temperature of the heater core 52 to become higher than the first threshold T2. This helps to reduce restarting of the engine 12 caused by a decrease in the temperature of the heater core 52. For example, it is possible to make the time period dT1, which is the time period during which the engine 12 is stopped, illustrated in FIG. 4, longer than the time period dT2 of the comparative example described earlier, and to continue the electric mode.

In some embodiments, the control system 60 may stop the ISG 36 when, after the temperature of the heater core 52 decreases to the first threshold T2, the temperature of the heater core 52 becomes higher than the second threshold T3. As a result, the water pump 42 may be stopped, and the supply of the coolant W to the heater core 52 may be stopped. This helps to prevent the heater core 52 from being heated unnecessarily, and therefore helps to reduce the amount of energy consumed in order to heat the heater core 52.

In a state in which the engine 12 is stopped, the temperature of the coolant W may tend to decrease with an increase in the time period during which the coolant W is circulated. For example, when the temperature of the heater core 52 does not reach the second threshold T3 despite the circulation of the coolant W, the coolant W may provably not have an amount of heat to be used to heat the heater core 52. Here, in the air conditioning system 11, the control system 60 starts the engine 12 when, after the temperature of the heater core 52 decreases to the first threshold T2, the temperature of the heater core 52 becomes equal to or lower than the third threshold T1 while the ISG 36 is being operated. As a result, the coolant W may be heated by the heat dissipated from the engine 12, helping to increase the temperature of the heater core 52 to at least the first threshold T2.

In the air conditioning system 11, when the traveling mode is switched from the electric mode to the engine mode, the control system 60 may engage the clutch 38 to operate the engine 12 by the ISG 36. In contrast, when the driving mode is switched from the engine mode to the electric mode, the control system 60 may stop the engine 12. In some embodiments, when the temperature of the heater core 52 decreases to the first threshold T2 after the engine 12 is stopped, the control system 60 may disengage the clutch 38 and drive the water pump 42 by the ISG 36. As described above, because it is possible to use the ISG 36 not only as a drive source to restart the engine 12 but also as a drive source of the water pump 42, it may be unnecessary to provide a drive source different from the ISG 36 to drive the water pump 42.

In some embodiments, the control system 60 may operate the ISG 36 when: the engine mode is switched to the electric mode, causing the engine 12 to be stopped; and thereafter the temperature of the heater core 52 decreases to the first threshold T2. This helps to prevent the engine 12 from being operated to heat the heater core 52. For example, the air conditioning system 11 helps to extend the time period during which the electric mode is selected as compared with the case where the present configuration is not provided.

### Second Example Embodiment

Hereinafter, an air conditioning system 90 of the second example embodiment will be described. Note that the same or similar components as those in the first example embodiment are denoted by the same reference numerals, and redundant description thereof will be omitted. For the components illustrated in FIGS. 1 to 4, indication of individual figure numbers will be omitted. In one embodiment, the air conditioning system 90 may serve as an “air conditioner for a vehicle”.

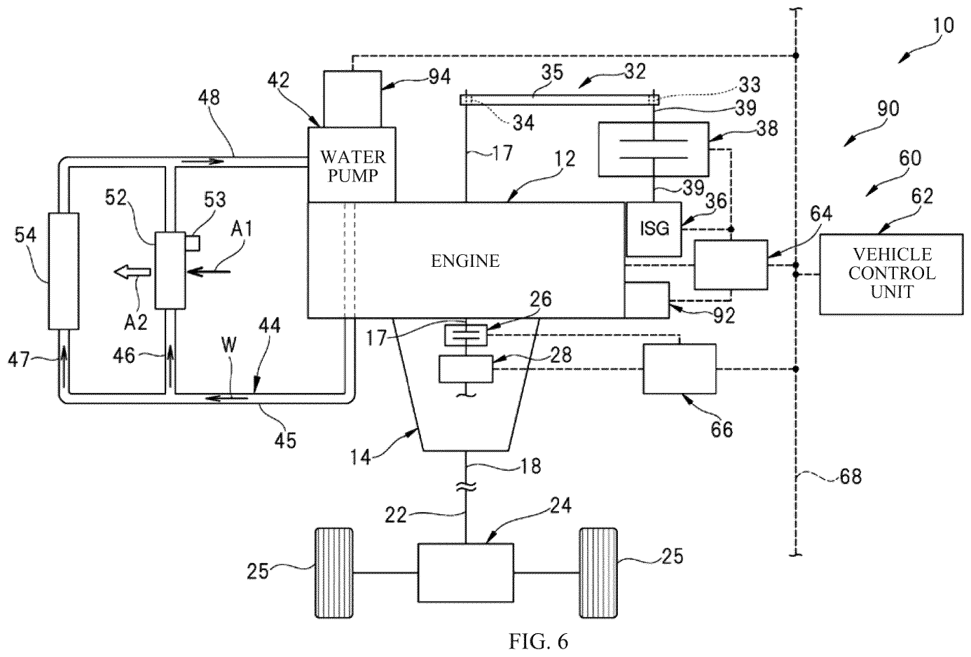

As illustrated in FIG. 6, in the air conditioning system 90, a drive source that operates the water pump 42 may be different from that in the air conditioning system 11 of the first example embodiment. For example, in the air conditioning system 90, a drive motor 94 may drive the water pump 42. The drive motor 94 may be an example of a pump motor and operated when electric power is supplied. The drive motor 94 may be controlled by the control system 60. In the air conditioning system 90, for example, the crankshaft 17 and the coupling shaft 39 of the ISG 36 may be coupled to each other by the belt mechanism 32. In one embodiment, the drive motor 94 may serve as a “pump motor”.

The engine 12 may be provided with a starter motor 92. The starter motor 92 may be an electric motor that cranks the crankshaft 17 by electric power supplied from the battery. The starter motor 92 may be used at the time of starting the engine 12. The ISG 36 may be used at the time of restarting the engine 12.

### Workings of Second Example Embodiment

In the air conditioning system 90, when the temperature of the heater core 52 decreases to the first threshold T2 after the engine 12 is stopped, the control system 60 operates the drive motor 94 to drive the water pump 42. As a result, the coolant W heated by receiving the heat dissipated from the engine 12 may be supplied to the heater core 52, causing the temperature of the heater core 52 to become higher than the first threshold T2. This helps to reduce restarting of the engine 12 caused by a decrease in the temperature of the heater core 52. For example, the configuration helps to continue the electric mode.

In the air conditioning system 90, when the temperature of the heater core 52 decreases to the first threshold T2 and thereafter becomes higher than the second threshold T3, the control system 60 may stop the drive motor 94. As a result, the water pump 42 may be stopped, and the supply of the coolant W to the heater core 52 may be stopped. This helps to prevent the heater core 52 from being heated unnecessarily, and therefore helps to reduce the amount of energy consumed in order to heat the heater core 52. As described above, in some embodiments, the drive motor 94 different from the ISG 36 may be used as the drive source of the water pump 42.

### Modification Examples

One example embodiment of the present disclosure is not limited to the first example embodiment or the second example embodiment, and various modifications are possible without departing from the scope of the disclosure.

The vehicle may not be limited to the hybrid electric vehicle 10. In some embodiments, the vehicle may include the engine 12 and not include the traveling motor 28. In such a vehicle, in some embodiments, the drive motor 94 may be operated when the temperature of the heater core 52 decreases to a threshold after the engine 12 is stopped.

In some embodiments, in the air conditioning system 11, the second threshold T3 may not be set. In some embodiments, in the air conditioning system 11, even if the temperature of the heater core 52 reaches the second threshold T3, the operation of the drive unit 30 may be continued. In some embodiments, in the air conditioning system 90 also, the second threshold T3 may not be set.

In some embodiments, in the air conditioning systems 11 and 90, a gear mechanism including multiple gears may be used instead of the belt mechanism 32. In some embodiments, a transmitter that transmits power by a chain and a sprocket may be used instead of the belt mechanism 32.

According to an air conditioner for a vehicle of at least one example embodiment of the disclosure, when a temperature of a heater core decreases to a threshold after an engine is stopped, a control system may operate a pump motor to drive a water pump. As a result, a coolant heated by receiving heat dissipated from the engine may be supplied to the heater core, causing the temperature of the heater core to become higher than the threshold. This makes it possible to reduce restarting of the engine caused by a decrease in the temperature of the heater core.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims. The disclosure is intended to include such modifications and alterations in so far as they fall within the scope of the appended claims or the equivalents thereof.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer, or step but not the exclusion of any other non-stated element, integer, or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

The engine control system 60 illustrated in FIGS. 1 and 6 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the engine control system 60. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the engine control system 60 illustrated in FIGS. 1 and 6.

1. An air conditioner for a vehicle, the air conditioner comprising:
a heater core coupled to a cooling pipe of an engine;
a water pump configured to circulate a coolant inside the cooling pipe;
a pump motor configured to drive the water pump; and
a control system comprising a processor and a memory communicably coupled to each other, the control system being configured to control the pump motor in accordance with a temperature of the heater core, wherein
the control system comprises a first threshold and a third threshold that are set in the control system, the third threshold being lower than the first threshold, and
the control system is configured to
operate the pump motor when a temperature of the heater core decreases to the first threshold after the engine is stopped, and
start the engine when, after the temperature of the heater core decreases to the first threshold, the temperature of the heater core becomes equal to or lower than the third threshold while the pump motor is being operated.

2. The air conditioner for the vehicle according to claim 1, wherein
the control system comprises a second threshold that is set in the control system, the second threshold being higher than the first threshold, and
the control system is configured to stop the pump motor when, after the temperature of the heater core decreases to the first threshold, the temperature of the heater core becomes higher than the second threshold.

3. The air conditioner for the vehicle according to claim 1, further comprising:
a transmitter provided in a power transmission path between the pump motor and the water pump; and
a clutch configured to engage and disengage the transmitter and a crankshaft of the engine with each other or from each other, wherein
the control system is configured to
engage the clutch when the engine is to be operated, and
disengage the clutch and drive the water pump by the pump motor when the temperature of the heater core decreases to the first threshold after the engine is stopped.

4. The air conditioner for the vehicle according to claim 1, wherein
the control system is configured to switch between an engine mode in which the vehicle is driven by the engine and an electric mode in which the vehicle is driven by a traveling motor, and
the control system is configured to operate the pump motor when: the engine mode is switched to the electric mode, causing the engine to be stopped; and thereafter the temperature of the heater core decreases to the first threshold.
